(19) United States
(12) Patent Application Publication
(10) Pub. No.: US 2009/0023374 A1
(43) Pub. Date: Jan. 22, 2009

(54) Air passage opening and closing device

(75) Inventors: Yoshihiro Suzuki, Hazu-gun (JP); Takahiro Tokunaga, Kosai-city (JP); Yoshikazu Sakaki, Obu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/218,728

(22) Filed: Jul. 17, 2008

(30) Foreign Application Priority Data
Jul. 18, 2007 (JP) 2007-186918
Mar. 4, 2008 (JP) 2008-053049

(51) Int. Cl. B60H 1/00

(52) U.S. Cl. 454/126; 454/145; 454/152; 29/505

(57) ABSTRACT

An air passage opening and closing device includes a case forming an opening portion, a sliding door, and a gear mechanism. The case has a case-side seal surface at two edges of the opening portion in a width direction of a door body of the sliding door, on which a first plate surface of the door body abuts. The gear mechanism includes a driven side gear molded integrally with the door body using resin. The driven side gear protrudes from a second plate surface of the door body on a side opposite to the first plate surface, and extends in parallel with a movement direction of the sliding door, at two edge portions of the second plate surface in the width direction. In addition, the driven side gear has a hollow space opened toward a direction parallel to the width direction.

### CROSS REFERENCE TO RELATED APPLICATION

This application is based on Japanese Patent Applications No. 2007-186918 filed on Jul. 18, 2007, and No. 2008-053049 filed on Mar. 4, 2008, the contents of which are incorporated herein by reference in its entirety.

### FIELD OF THE INVENTION

The present invention relates to an air passage opening and closing device for opening and closing an opening portion of an air passage by using a sliding door, and to a method of manufacturing the device. The air passage opening and closing device is suitable for use in an air conditioner for a vehicle, for example.

### BACKGROUND OF THE INVENTION

Conventionally, an air conditioner for a vehicle using such an air passage opening and closing device is disclosed in, for example, U.S. Pat. No. 6,450,877 (corresponding to JP Patent No. 3824105). In the air conditioner of the related art, a sliding door including a plate-like door body is slidably disposed in a case for forming an opening portion of an air passage, so as to open and close the opening portion of the air passage.

In the related art, a seal surface is formed on a side of the case at a peripheral edge of the opening portion. When the sliding door closes the opening portion of the air passage, a plate surface of the door body on a downstream air side abuts against the seal surface on the case so as to have a sealing property.

In the related art, a driven side gear is disposed on a plate surface of the door body at an upstream air side and is engaged with a driving side gear, to drive the sliding door. The driven side gear is formed to protrude to the upstream air side at both edges in a door width direction of the plate surface of the door body and to extend in a direction of movement of the door.

Detailed studies by the inventors of the present application have shown that integral molding of the door body and the driven side gear using resin may result in failure in the related art.

Generally, because the driven side gear is thicker than the door body, a cooling rate of the driven side gear is lower that that of the door body in molding. Thus, the molded structure of the resin due to the cooling may not be constant between the door body and the driven side gear, thereby causing deformation of a connection portion between the door body and the driven side gear due to a constriction force.

The driven side gear having a large thickness may cause a phenomenon of formation of a recess on the surface thereof, that is, the so-called “sink” in the molding.

### SUMMARY OF THE INVENTION

In view of the foregoing problems, the inventors of the present application have made samples and studied this problem. FIG. 13A is a sectional view showing a part of an air conditioner for a vehicle (hereinafter referred to as an examination example) made and studied by the inventors of the present application, and FIG. 13B is an enlarged perspective view of a driven side gear 32 in the examination example.

In the examination example, a hollow recessed space 32a (hollow space) is provided in the driven side gear 32. Thus, the driven side gear 32 is thinned, so that the driven side gear 32 has approximately the same thickness as that of a door body 30. In this case, the door body 30 and the driven side gear 32 have a uniform cooling rate in molding, thereby preventing a deformation of the connection portion between the door body 30 and the driven side gear 32 due to the constriction force. Provision of the recessed space 32a makes the driven gear 32 thinner so as to prevent the occurrence of the “sink”.

In this examination example, the recessed space 32a is opened at a plate surface 30a of the door body 30 on the downstream air side (on the upper side shown in FIG. 13A). As indicated by a broken line shown in FIG. 13A, the sealing performance cannot be obtained at the opening portion of the recessed space 32a when a case-side seal surface 24a is made shorter.

For this reason, in the examination example, the case-side seal surface 24a is protruded largely toward the center of the door body 30 (to the right side shown in FIG. 13A) in the door width direction W (in the left-right direction shown in FIG. 13A), so that the plate surface 30a on the downstream air side abuts against the protrusion of the case-side seal surface 24a thereby to ensure the sealing performance.

For illustrative convenience, in FIG. 13A, the plate surface 30a on the downstream air side is spaced apart from the case-side seal surface 24a, but actually abuts against the case-side seal surface 24a.

In this examination example, however, because the case-side seal surface 24a protrudes largely toward the inner side of the door body 30, an area of a defroster opening 24 may be decreased, resulting in an increase in ventilating resistance.

The present invention has been made in view of the foregoing problems, and it is an object of the invention to provide an integral molding of a door body and a driven side gear using resin, while preventing a decrease in area of an opening portion of an air passage.

It is another object of the present invention to provide an air passage opening and closing device for opening and closing an opening portion of an air passage, and/or a method of manufacturing the device, which improves a sealing performance while preventing a decrease in area of the opening portion of the air passage.

According to an aspect of the present invention, an air passage opening and closing device includes a case configured to define an opening portion of an air passage, a sliding door slidably disposed in the case to open and close the opening portion, and a gear mechanism configured to drive the sliding door and to move the sliding door in a door movement direction. The sliding door includes a resinous door body having a plate-like shape, and the door body has first and second plate surfaces opposite to each other. The case has a case-side seal surface at two edges of the opening portion in a width direction of the door body, and the case-side seal surface is adapted to abut against the first plate surface of the door body. The gear mechanism includes a driven side gear that is integrally molded with the door body using resin, and a driving side gear that is located to be engaged with the driven side gear. Furthermore, the driven side gear protrudes from the second plate surface of the door body and extends in a direction parallel with the door movement direction, at two edge portions of the second plate surface of the door body in the width direction. In addition, the driven side gear has a hollow space opened toward a direction parallel to the width direction.

Because the hollow space (hollow recessed space) is formed in the driven side gear, it can prevent a deformation of a connection portion between the door body and the driven side gear due to a contraction force in the resin molding, and also the “sink” in the driven side gear when the door body and the driven side gear are integrally molded using resin, for the same reason as that in the above-mentioned examination example.

Furthermore, the hollow space is opened in the width direction of the door body, but the hollow space is not opened to the plate surface of the door body.

Thus, it is not necessary to cause the case-side seal surface to largely protrude toward the inner side (center side) of the door body in the width direction in order to ensure the sealing performance, unlike the examination example. As a result, the area of the opening portion is not reduced, unlike the examination example.

For example, the hollow space may be opened from an inner side of the door body toward an outside of the door body in the width direction. Alternatively, the hollow space may be opened from an outside of the door body toward an inner side of the door body in the width direction.

Furthermore, the door body and the driven side gear may be integrally molded to have a burr that is positioned at a portion of the door body, other than a contact portion of the door body that contacts the case-side seal surface.

The case may be configured to have a guide wall surface on which the driven side gear slides, and the guide wall surface may be opposite to the case-side seal surface. In this case, the door body and the driven side gear are integrally molded to have a burr that is positioned at a portion of the door body other than a contact portion of the door body that contacts the case-side seal surface, and at a portion of the driven side gear other than a contact portion of the driven side gear that contacts the guide wall surface.

In the air passage opening and closing device, the door body and the driven side gear can be formed to have approximately a uniform thickness. Thus, the deformation and the “sink” can be further restricted.

Generally, the driven side gear has a plurality of protrusion portions each of which is connected with the second plate surface of the door body to define the hollow space. In this case, the protrusion portions are continuously arranged on the second plate surface of the door body in the door movement direction, and the protrusion portion is open only toward the width direction at least at one end side.

Furthermore, the first plate surface of the door body may be positioned on a downstream air side in a flow direction of air flowing in the air passage, and the second plate surface of the door body may be positioned on an upstream air side in the flow direction. In addition, the door movement direction may be set substantially perpendicular to the width direction.

According to another aspect of the present invention, a method for manufacturing the air passage opening and closing device includes a step of integrally molding the door body and the driven side gear by a forming die. In this case, the forming die includes a cavity die and a core die that are divided into a side of the first plate surface and a side of the second plate surface, and a slide core die for forming the hollow space. Furthermore, a die matching position between the slide core and one of the cavity die and the core die on the side of the first plate surface is set in a portion of the door body, other than a contact portion of the door body contacting the case-side seal surface. Thus, the method has an improved sealing performance while the air passage opening and closing device prevents a decrease in area of the opening portion of the air passage.

According to another aspect of the present invention, a method for manufacturing the air passage opening and closing device includes a step of integrally molding the door body and the driven side gear by a forming die. Furthermore, the forming die includes a cavity die and a core die that are divided into a side of the first plate surface and a side of the second plate surface, and a slide core die for forming the hollow space. In this case, a die matching position between the slide core and one of the cavity die and the core die on the side of the first plate surface is set in a portion of the door body other than a contact portion of the door body contacting the case-side seal surface, and a die matching position between the slide core and the other one of the cavity die and the core die on the side of the second plate surface is set in a portion of the driven side gear other than a contact portion of the driven side gear contacting the guide wall surface. Thus, the method has an improved sealing performance while the air passage opening and closing device prevents a decrease in area of the opening portion of the air passage.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a sectional view of an interior air conditioning unit of an air conditioner for a vehicle according to a first embodiment of the invention;

FIG. 2 is a sectional view taken along the line II-II of FIG. 1;

FIG. 3 is a sectional view taken along the line III-III of FIG. 1;

FIG. 4 is an enlarged perspective view of a part of the interior air conditioning unit in the first embodiment;

FIG. 5 is an enlarged sectional view of a part of the interior air conditioning unit in the first embodiment;

FIG. 6 is an enlarged perspective view of a part of a driven side gear portion in the first embodiment;

FIGS. 7A and 7B are schematic diagrams showing a first example of a method for integrally molding a door body and a driven side gear, in the first embodiment;

FIGS. 8A and 8B are schematic diagrams showing a second example of a method for integrally molding a door body and a driven side gear, in the first embodiment;

FIGS. 9A and 9B are schematic diagrams showing a third example of a method for integrally molding a door body and a driven side gear, in the first embodiment;

FIGS. 10A and 10B are schematic diagrams showing a fourth example of a method for integrally molding a door body and a driven side gear, in the first embodiment;

FIG. 11 is a partially enlarged sectional view showing a part of an interior air conditioning unit according to a second embodiment of the invention;

FIG. 12 is a sectional view showing a defroster/face door portion of the interior air conditioning unit in the second embodiment;

FIG. 13A is an enlarged sectional view of an interior air conditioning unit taken as an examination example by the inventors; and

FIG. 13B is an enlarged perspective view showing a driven side gear of FIG. 13A.

### DETAILED DESCRIPTION OF THE PREFERRED EMBODIMENTS

### First Embodiment

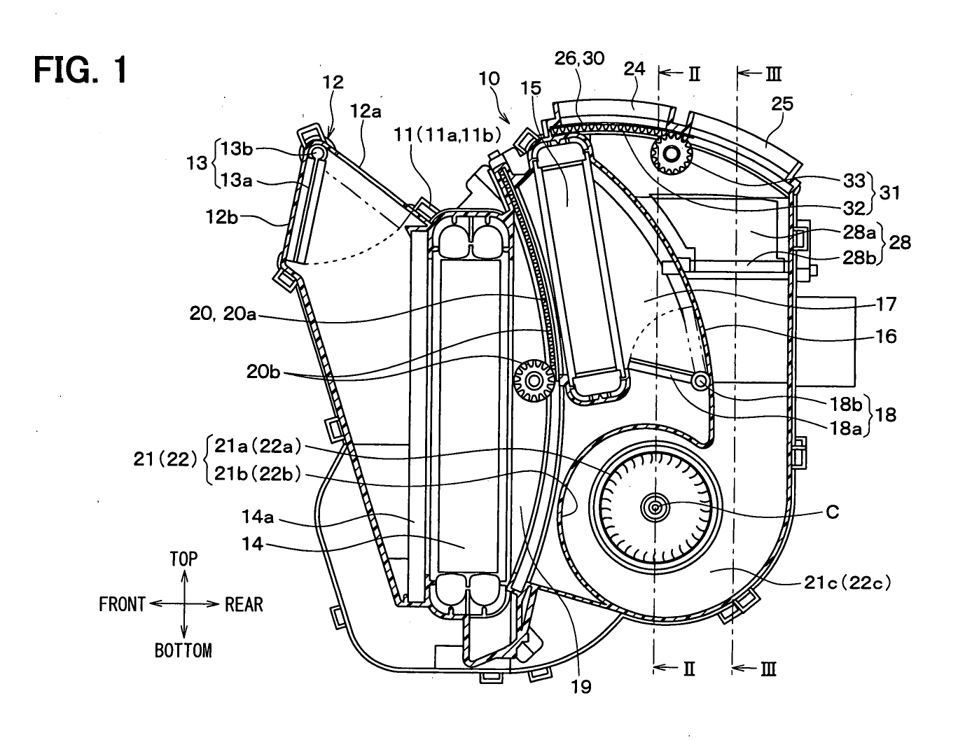

A first embodiment of the invention will be described below based on FIGS. 1 to 10B.

An interior air conditioning unit 10 is disposed substantially at a center area of a vehicle in a width direction (vehicle left-right direction) inside a dashboard (instrument panel) that is disposed at the front of a vehicle compartment. The interior air conditioning unit 10 includes a case 11 for forming an outer shell and an air passage through which air is blown toward the inside of the compartment. The case 11 has elasticity to some degree, and is molded using resin having excellent strength (for example, polypropylen).

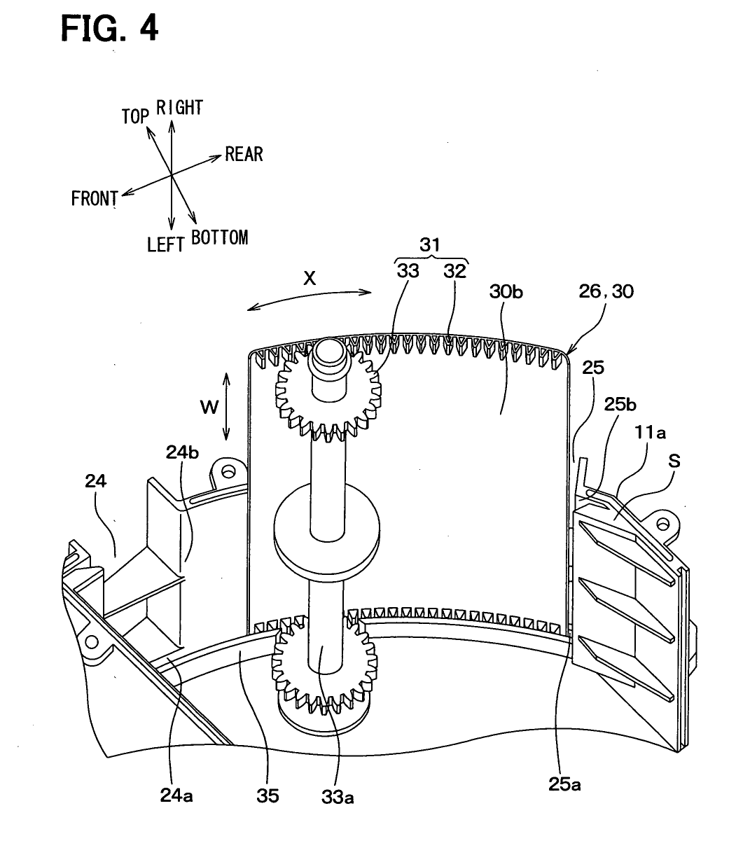

The case 11 has a division surface S (see FIG. 4 to be described later) formed vertically substantially at the center in the width direction, and can be divided into two left and right division portions 11a and 11b at the division surface S. The two left and right division portions 11a and 11b are integrally connected to each other by connection mean, such as a metallic spring, a clip, a screw, or the like, after respective devices including an evaporator 14, a heater core 15, and the like to be described later are accommodated therein.

As shown in FIG. 1, an inside/outside air switching portion 12 for switching between the inside air (i.e., air inside the vehicle compartment) and outside air (i.e., air outside the compartment) to introduce the selected one thereinto or both is provided in the most upstream part of the air passage formed in the case 11 on the vehicle front and upper side of the case 11. The inside/outside air switching portion 12 has an inside air introduction port 12a for introducing the inside air into the case 11 and an outside air introduction port 12b for introducing the outside air into the case 11.

An inside/outside air switching door 13 for opening and closing the inside air introduction port 12a and the outside air introduction port 12b is rotatably disposed in the inside/outside air switching portion 12. Specifically, the inside/outside air switching door 13 is a so-called cantilever door in which a rotary shaft 13b extending in the vehicle width direction is integrally connected with one end of the plate-like door body 13a.

In the inside/outside air switching portion 12, the rotary shaft 13b is rotated by a servo motor not shown or by a manual operation to rotatably displace the door body 13a, so that opening areas of the inside air introduction port 12a and the outside air introduction port 12b can be continuously adjusted.

The evaporator 14 is disposed substantially in the up-down direction (substantially in the vertical direction) on a downstream side of an air flow of the inside/outside air switching portion 12. The evaporator 14 is one device included in the known vapor compression refrigeration cycle (not shown). That is, the evaporator 14 is a heat exchanger for cooling air to be blown into the compartment by evaporating low-pressure refrigerant in the refrigeration cycle. The low-pressure refrigerant in the refrigeration cycle is evaporated by absorbing heat from air passing through the evaporator 14, so that air is cooled.

A filter 14a is provided at an upstream air side of the evaporator 14 so as to cover the entire surface of a heat exchange surface (core surface) of the evaporator 14. The filter 14a traps dust or the like in the inside air or/and outside air flowing from the inside/outside air switching portion 12 into the case 11.

A heater core 15 is disposed on a rear and upper side of the vehicle at a downstream air side of the evaporator 14. The heater core 15 is a heat exchanger for heating that allows a high-temperature engine coolant circulating through an engine coolant circuit (not shown) to flow thereinto, and which exchanges heat between the engine coolant and air cooled by the evaporator 14 thereby heating the air to have a desired temperature.

The heater core 15 is disposed substantially vertically such that the lower side of the heater core 15 is slightly inclined toward the vehicle rear side with respect to the upper side thereof, as shown in FIG. 1. This ensures an operating space of an air mix door 20 to be described later. The sentence “the evaporator 14 and the heater core 15 are disposed substantially vertically” means that a heat exchange surface (core surface) is disposed to extend substantially vertically.

A warm air passage 17 serving as a ventilating passage of the heater core 15 is formed on the rear and upper side of the evaporator 14. A wall portion 16 constituting a part of an inner wall surface of the warm air passage 17 is integrally formed with the case 11 on the vehicle rear side of the heater core 15.

The wall portion 16 extends curved approximately in an arc shape in the vertical direction of the vehicle. Thus, the warm air passage 17 is formed to extend from the upper side to the lower side on the vehicle rear side of the heater core 15, and thereby warm air heated by the heater core 15 flows from the upper side to the lower side.

A warm air guide member 18 for guiding a flow of warm air is disposed on the most downstream portion of the warm air passage 17. The warm air guide member 18 has a cantilever door structure similar to that of the inside/outside air switching door 13.

In the warm air guide member 18, a rotary shaft 18b extending in the vehicle width direction is rotated by a servo motor not shown or manual operation to rotatably displace a plate-like body 18a connected to the rotary shaft 18b, thereby changing the direction of a warm air flow from the warm air passage 17.

A cool air passage 19 is formed on the rear side of the evaporator 14 and on the lower side of the heater core 15. The cool air passage 19 is a bypass passage through which the cool air having passed through the evaporator 14 bypasses the heater core 15.

The air mix door 20 is disposed directly after the evaporator 14 to adjust a ratio of an amount of cool air flowing into the warm air passage 17 to an amount of cool air flowing into the cool air passage 19. The air mix door 20 includes a plate-like door body 20a curved and extending in an arc shape in the vertical direction of the vehicle. The air mix door 20 is a sliding door for driving and displacing the door body 20a via a gear mechanism 20b in a curved direction of the door body 20a by a servo motor (not shown) or a manual operation.

More specifically, a sliding movement of the door body 20a of the air mix door 20 in the upward direction of the vehicle increases an opening degree of the cool air passage 19, while decreasing an opening degree of the warm air passage 17. Conversely, a sliding movement of the door body 20a in the downward direction of the vehicle decreases the opening degree of the cool air passage 19, while increasing the opening degree of the warm air passage 17.

Adjustment of the opening degree of the air mix door 20 adjusts the ratio of an amount of cool air to an amount of warm air drawn into first and second blowers 21 and 22, thereby adjusting the temperature of air blown from the first and second blowers 21 and 22 into the inside of the vehicle compartment. That is, the air mix door 20 constitutes a temperature adjustment unit that adjusts the temperature of air to be blown into the vehicle compartment.

The first and second blowers 21 and 22 for blowing air toward the inside of the vehicle compartment are disposed on a downstream side of the air flow of the evaporator 14 and the heater core 15, more specifically, on the downstream side of the warm air passage 17 and on the downstream side of the cool air passage 19. As shown in FIG. 1, the first and second blowers 21 and 22 are positioned at a vehicle lower side of the warm air passage 17 and at a vehicle rear side of the cool air passage 19.

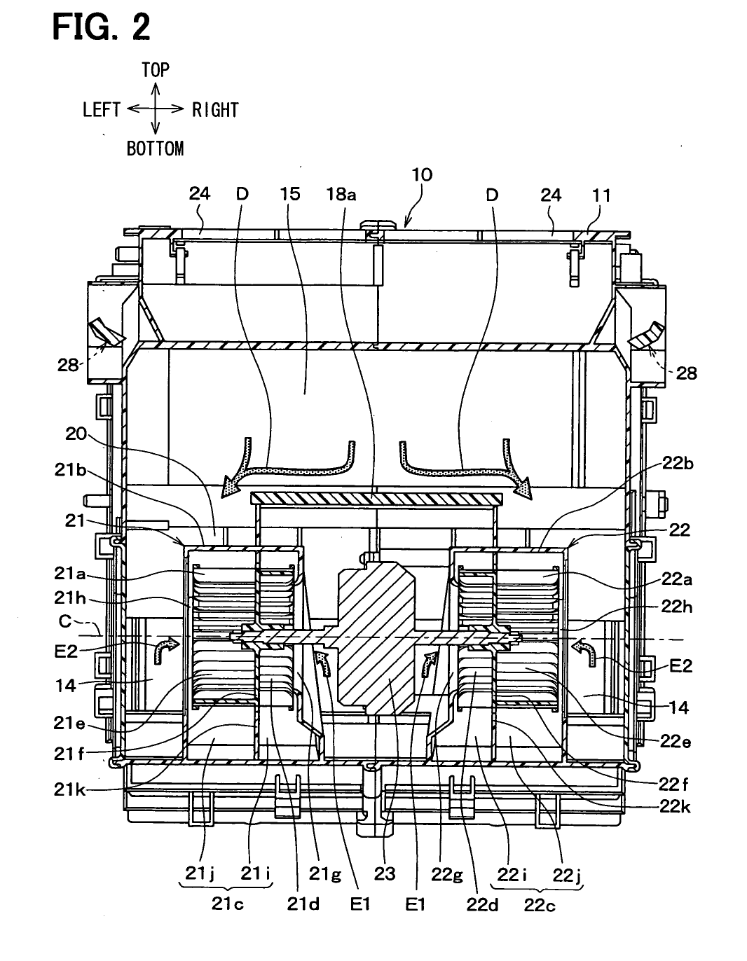

As shown in FIG. 2, the first and second blowers 21 and 22 have the same basic structure. The first blower 21 includes a known centrifugal multi-blade fan 21a having a plurality of pieces of blades spaced apart with a certain distance therebetween and arranged in an annular shape around a rotary axis C extending in the vehicle width direction. The first blower 21 also includes a scroll casing 21b or the like adapted to accommodate therein the centrifugal multi-blade fan 21a and to form an outflow passage 21c through which air flowing from the multi-blade fan 21a passes.

The centrifugal multi-blade fan 21a is a double suction type blower fan for sucking air from both sides in the direction of the rotary axis C. Furthermore, a substantially flat plate-like boss 21f is provided in the centrifugal multi-blade fan 21a. The boss 21f is adapted to partition an internal space of the centrifugal multi-blade fan 21a into a first fan portion 21d and a second fan portion 21e in the direction perpendicular to the rotary axis C.

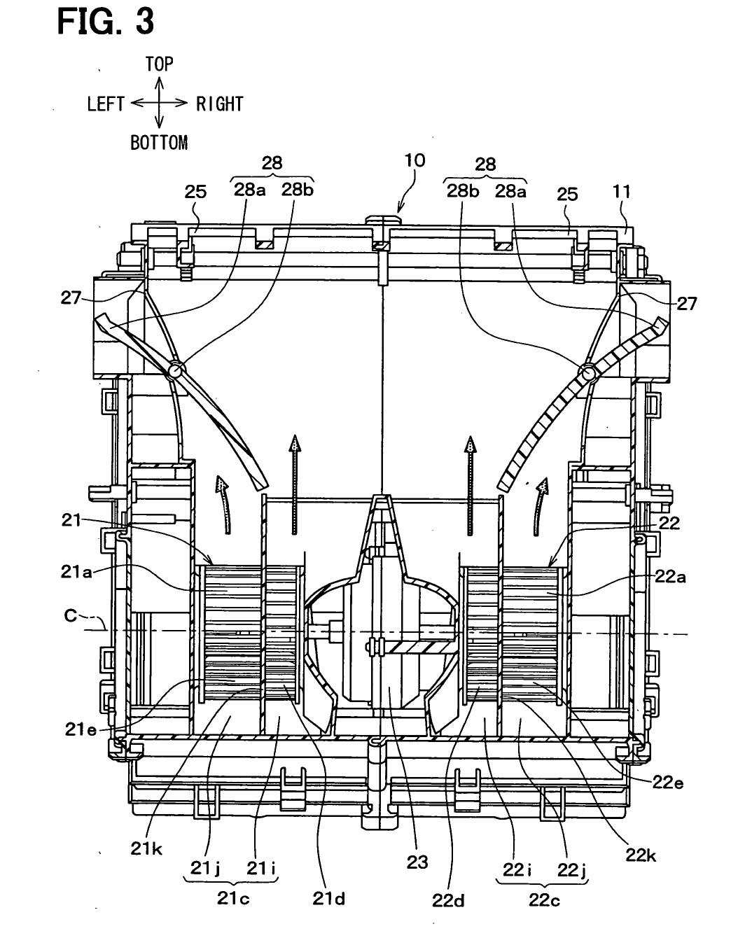

In this embodiment, as shown in FIGS. 2 and 3, the first fan portion 21d is disposed on the right side in the vehicle width direction of the first blower 21, and the second fan portion 21e is disposed on the left side in the vehicle width direction of the first blower 21. An air suction port on the first fan portion 21d side is a first suction port 21g, and an air suction port on the second fan portion 21e side is a second suction port 21h.

The scroll casing 21b is a fan casing having such a spiral shape that gradually enlarges a sectional area of the outflow passage 21c toward the rotation direction of the centrifugal multi-blade fan 21a, and is also integrally formed with the case 11. Two openings are provided in positions corresponding to the first suction port 21g and the second suction port 21h. Thus, air is drawn into the first suction port 21g and the second suction port 21h via the two openings.

A partition plate 21k is provided in the scroll casing 21b to partition the outflow passage 21c into a first outflow passage 21i through which an outflow air on the first fan side flowing from the first fan portion 21d passes, and a second outflow passage 21j through which an outflow air on the second fan side flowing from the second fan portion 21e passes.

Next, the second blower 22 includes a centrifugal multi-blade fan 22a, and a scroll casing 22b, similarly to the first blower 21. The second blower 22 is disposed on the right side in the vehicle width direction with respect to the first blower 21, and the centrifugal multi-blade fan 22a of the second blower 22 is coaxially disposed with respect to the centrifugal multi-blade fan 21a of the first blower 21.

The same type of boss as that of the first blower 21, namely, a boss 22f is provided also in the centrifugal multi-blade fan 22a of the second blower 22 to form a first fan portion 22d and a second fan portion 22e. Contrary to the first blower 21, in the second blower 22, the first fan portion 22d (first suction port 22g) is disposed on the left side in the vehicle width direction of the second blower 22, and the second fan portion 22e (second suction port 22h) is disposed on the right side in the vehicle width direction of the second blower 22.

Thus, the first fan portions 21d and 22d of the first and second centrifugal multi-blade fans 21a and 22a are disposed on the respective sides opposed to each other.

Furthermore, a partition plate 22k is provided in the scroll casing 22b of the second blower 22, to partition the outflow passage 22c into a first outflow passage 22i through which the outflow air on the first fan side flowing from the first fan portion 22d passes, and a second outflow passage 22j through which the outflow air on the second fan side flowing from the second fan portion 22e passes.

Each of the centrifugal multi-blade fans 21a and 22a receives a rotation driving force transferred from a common electric motor 23 disposed substantially in the center of the vehicle width direction between the blowers 21 and 22, and blows the air therefrom. It is apparent that two electric motors 23 may be provided to rotatably drive the centrifugal multi-blade fans 21a and 22a independently.

As shown in FIG. 2, the body 18a of the warm air guide member 18 is formed such that a range (length) of the body 18a in the vehicle width direction is set in an area (length) between the boss 21f (partition plate 21k) of the first blower 21 and the boss 22f (partition plate 22k) of the second blower 22.

This arrangement of the body 18a is adapted to interrupt a direct flow of warm air from the heater core 15 toward the first suction ports 21g and 22g of the first and second blowers 21 and 22. Thus, the warm air heated by the heater core 15 is difficult to flow toward the first suction ports 21g and 22g, but flows toward the second suction ports 21h and 22h, as indicated by the arrow D in FIG. 2.

In contrast, the cool air cooled by the evaporator 4 flows toward the first suction ports 21g and 22g as indicated by the arrow E1, and also flows toward the second suction ports 21h and 22h as indicated by the arrow E2. Thus, the first suction ports 21g and 22g allow the cool air cooled by the evaporator 14 to be sucked thereinto in priority, and the second suction ports 21h and 22h allow a mixed air of the cool air cooled by the evaporator 14 and the warm air heated by the heater core 15 to be sucked thereinto also in priority.

The rotary shaft 18b of the warm air guide member 18 extends in parallel to the rotary axis C of the first and second blowers 21 and 22, so that a heat exchange surface (core surface) of the evaporator 14 and a heat exchange surface (core surface) of the heater core 15 are respectively disposed approximately in parallel to the rotary axis C.

As shown in FIG. 1, a defroster opening 24 for blowing out air blown from the first and second blowers 21 and 22 toward a front window glass (windshield) of the vehicle is provided substantially in a center area in the vehicle front-rear direction at an upper surface of the case 11. The defroster opening 24 is an example of an opening portion of an air passage in the invention.

The air passing through the defroster opening 24 is blown out toward the inner surface of the front window glass of the vehicle via a defroster outlet provided on a defroster duct (not shown) and an upper surface of the instrument panel of the vehicle.

A face opening 25 for blowing the air blown from the first and second blowers 21 and 22 toward a face area of a passenger in the vehicle compartment is provided back the defroster opening 24 and on an upper surface portion of the case 11. Specifically, the air passing through the face opening 25 is blown out toward an upper area of the passenger in the vehicle compartment via a face duct not shown and a face air outlet provided at the front surface of the instrument panel of the vehicle or the like.

A defroster/face door (air-outlet mode switching door) 26 is disposed directly under the defroster opening 24 and the face opening 25 so as to adjust the amount of conditioned air passing through the defroster opening 24 and of conditioned air passing through the face opening 25.

The defroster/face door 26 is a sliding door, and includes a resin door body 30 formed in a plate-like shape curved and extending in an arc shape in the front-rear direction of the vehicle. The door body 30 is configured to be drivingly displaced in the direction of curve of the door body 30 via a gear mechanism 31 by using a servo motor not shown or a manual operation.

More specifically, the door body 30 of the defroster/face door 26 is moved toward the rear side of the vehicle to enable an increase in opening degree of the defroster opening 24. Conversely, the door body 30 is moved toward the front side of the vehicle to enable an increase in opening degree of the face opening 25.

As shown in FIG. 3, foot openings 27 for blowing air blown from the first and second blowers 21 and 22 toward the foot area of the passenger in the vehicle compartment are provided at the upper parts of both sides of the case 11 in the vehicle width direction. Specifically, the air passing through the foot opening 27 is blown out toward the foot area of the passenger in the vehicle compartment via a foot duct not shown and a foot air outlet provided near the foot of the passenger in the compartment.

A foot door (air-outlet mode switching door) 28 for opening and closing the foot opening 27 is disposed in each opening 27. The foot door 28 is a so-called butterfly door in which a rotary shaft 28b extending in the vehicle front-rear direction is integrally connected substantially to the center of a plate-like door body 28a. The rotary shaft 28b is rotated by a servo motor not shown or a manual operation thereby to rotatably displace the door body 28a, thereby opening and closing the foot opening 27.

One of the tips of the foot doors 28 each is formed in such a shape that extends toward the tip of a corresponding one of the partition plates 21k and 22k for partitioning the outflow passages 21c and 22c of the respective blowers 21 and 22 located near the foot opening 27 opened. That is, each of the foot doors 28 is formed in such a shape that guides air on the second fan portion blown from the second outflow passages 21j and 22j of the blowers 21 and 22 toward the foot opening 27 side.

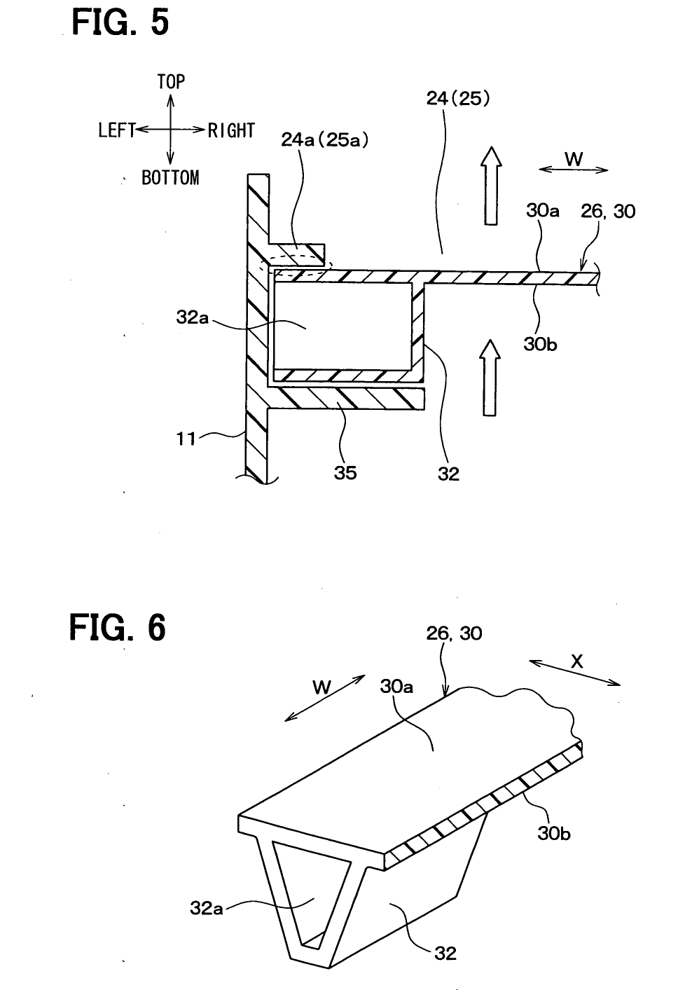

FIG. 4 is an enlarged perspective view of a part of the interior air conditioning unit 10, showing the detailed structure of the defroster/face door 26. FIG. 5 is an enlarged sectional view of a connection part of the defroster/face door 26 and the case 11.

In FIG. 4, the arrow W indicates a width direction of the door body 30 of the defroster/face door 26 (hereinafter referred to as a “door width direction W”), and the arrow X indicates a movement direction of the defroster/face door 26 (hereinafter referred to as a “door movement direction X”). For illustrative convenience, FIG. 4 shows only a left division portion 11a among two left and right division portions 11a and 11b that are configured to constitute the case 11.

FIG. 5 is a sectional view of a part of the defroster opening 24, which is similar to a sectional view of the face opening 25. A reference numeral corresponding to an element of the face opening 25 is given in a parenthesis of FIG. 5, which omits a sectional view of the face opening 25.

In the example of FIGS. 4 and 5, the door width direction W is identical to the vehicle width direction, and the door movement direction X is substantially in parallel to the front-rear direction of the vehicle.

Case side seal surfaces 24a extending in the door movement direction X are formed on both edges of the defroster opening 24 in the door width direction W. Case side seal surfaces 24b extending in the door width direction W are formed on both edges of the defroster opening 24 in the door movement direction X.

When the defroster/face door 26 closes the defroster opening 24, the plate surface 30a of the door body 30 on the downstream air side (on the upper side shown in FIG. 5) abuts against the case-side seal surfaces 24a and 24b to exhibit the sealing performance.

Likewise, case-side seal surfaces 25a extending in the door movement direction X are formed on both edges of the face opening 25 in the door width direction W. Case-side seal surfaces 25b extending in the door width direction W are formed on both edges of the face opening 25 in the door movement direction X.

When the defroster/face door 26 closes the face opening 25, the plate surface 30a of the door body 30 on the downstream air side abuts against the case-side seal surfaces 25a and 25b to exhibit the sealing performance at the face opening 25.

A seal member made of urethane foam or the like may be bonded to the plate surface 30a on the downstream air side, so that the plate surface 30a on the downstream air side may abut against the case-side seal surfaces 24a, 24b, 25a, 26b via the seal member.

The gear mechanism 31 for driving the defroster/face door 26 includes a driven side gear 32 integrally molded with the door body 30 by using a resin, and a circular driving side gear 33 in engagement with the driven side gear 32.

The driven side gear 32 protrudes from each edge in the door width direction W of the plate surface 30b of the door body 30 on the upstream air side (the lower side shown in FIG. 5) toward the side opposite to the plate surface 30a on the downstream air side (the lower side shown in FIG. 5), and extends in parallel to the door movement direction X. That is, the driven side gear 32 is continuously provided in the door movement direction X, at two edge portions of the plate surface 30b in the door width direction W. As shown in FIG. 4, the driven side gear 32 has a plurality of protrusion portions each of which is formed integrally with the plate surface 30b of the door body 30 to define the hollow recessed space 32a. Furthermore, the protrusion portions of the driven side gear 32 are continuously arranged on the plate surface 30b of the door body 30 in the door movement direction X, and each protrusion portion is open only toward the width direction at least at one end side.

The driving side gear 33 includes a driving shaft 33a extending in the door width direction W. Two end portions of the driving shaft 33a are rotatably supported by bearing holes (not shown) of a side wall of the case 11. One end of the driving shaft 33a is connected to a door driving device (servo motor or the like) not shown. In this embodiment, the driving side gear 33 and the driving shaft 33a are integrally formed using resin.

A guide wall surface 35 opposed to the case-side seal surfaces 24a and 25a are formed on the side wall of the case 11. Both ends of the door body 30 in the door width direction W are slidably supported between the guide wall surface 35 and the case-side seal surface 24a, 25a. That is, the guide wall surface 35, and the case-side seal surface 24a, 25a are configured to form a guide groove for guiding the sliding movement of the defroster/face door 26.

FIG. 6 is an enlarged perspective view of the driven side gear 32. A hollow recessed portion 32a (hollow portion) which is opened in the door width direction W is formed in the driven side gear 32.

In this embodiment, the recessed space 32a is opened from the center side of the door body 30 (from the right side shown in FIG. 6) toward the outside (toward the left side shown in FIG. 6) in the door width direction W. That is, the recessed space 32a is laid from the outside.

The air mix door 20 has the same basic structure as that of the above-mentioned defroster/face door 26, and a description of the detailed structure of the air mix door 20 will be omitted below.

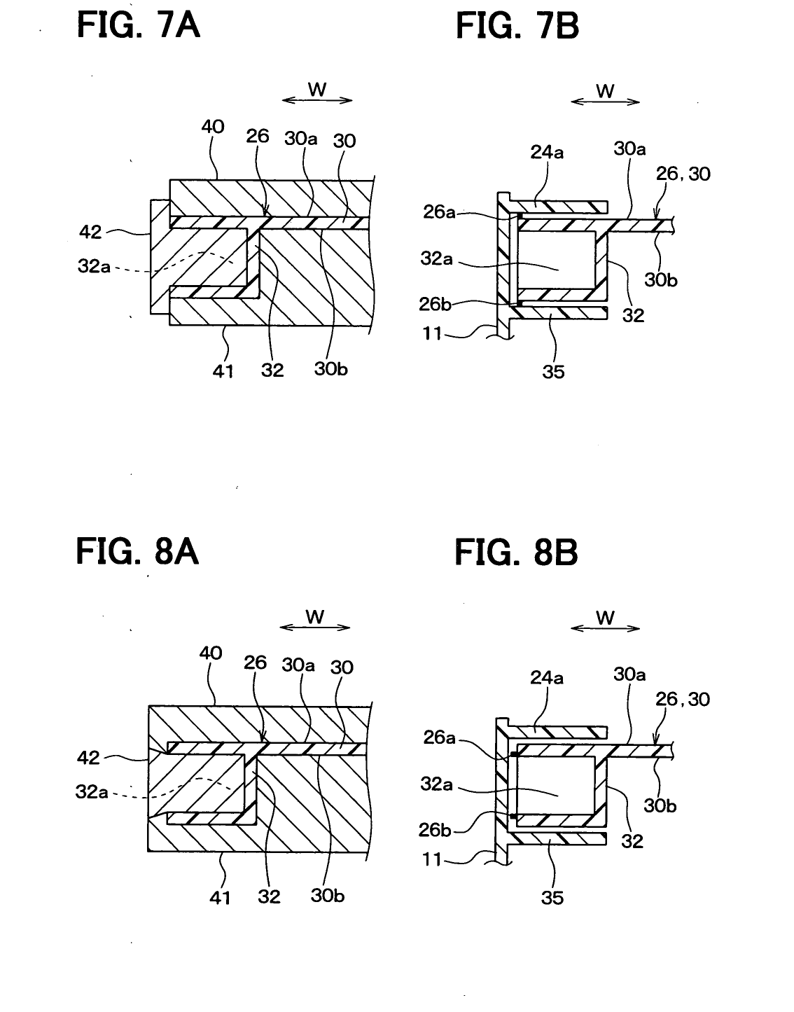

Examples of a method for integrally molding the door body 30 and the driven side gear 32 will be briefly described below based on FIGS. 7A to 10B. A forming die for integrally molding the door body 30 and the driven side gear 32 includes a cavity die (fixed die plate) 40 and a core die (movable die plate) 41 which are divided into the plate surface 30a on the downstream air side and the plate surface 30b on the upstream air side. The forming die also includes a slide core die 42 for forming the recessed space 32a serving as an undercut portion.

In the examples shown in FIGS. 7A to 10B, the cavity die 40 is positioned on the plate surface 30a at the downstream air side, and the core die 41 is positioned on the plate surface 30b at the upstream air side. Conversely, the core die 41 may be positioned on the plate surface 30a at the downstream air side, and the cavity die 40 may be positioned on the plate surface 30b at the upstream air side.

In the first example shown in FIGS. 7A and 7B, as shown in FIG. 7A, a die matching surface between the cavity die 40 and the core die 41, and the slide core die 42 is orthogonal to the door width direction W at both edges of the defroster/face door 26 in the door width direction W.

Thus, as shown in FIG. 7B, burrs 26a and 26b occurring in a die matching portion protrude in the direction perpendicular to the door width direction W at both edges of the defroster/face door 26 in the door width direction W. In the example of FIG. 7B, the burrs 26a and 26b protrude in the vertical direction (top-bottom direction).

In a second example shown in FIGS. 8A and 8B, as shown in FIG. 8A, a die matching surface between the cavity die 40 and the core die 41, and the slide core die 42 is substantially in parallel to the door width direction W at both edges of the defroster/face door 26 in the door width direction W.

Thus, as shown in FIG. 8B, burrs 26a and 26b occurring in a die matching portion protrude substantially in parallel to the door width direction W at both edges of the defroster/face door 26 in the door width direction W.

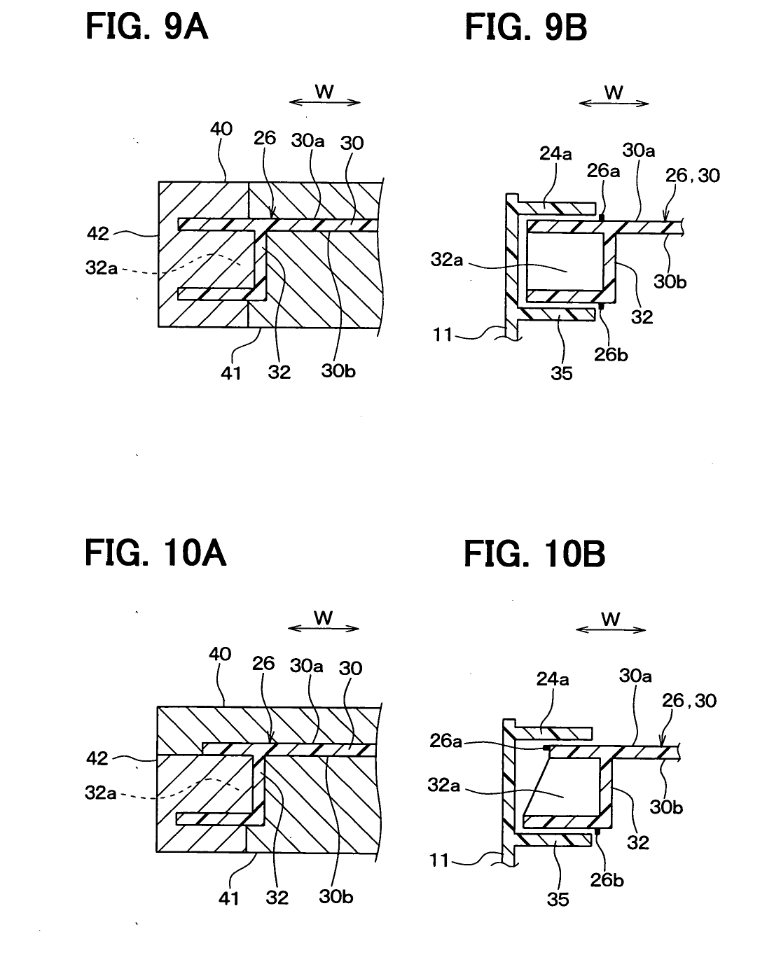

In a third example shown in FIGS. 9A and 9B, as shown in FIG. 9A, a die matching surface between the cavity die 40 and the core die 41, and the slide core die 42 is orthogonal to the door width direction W in a position apart from both edges of the defroster/face door 26 in the door width direction W by a predetermined distance.

Thus, as shown in FIG. 9B, burrs 26a and 26b occurring in a die matching portion protrude in the direction perpendicular to the door width direction W at the position apart from both edges of the defroster/face door 26 in the door width direction W by a predetermined distance. In the example of FIG. 9B, the burrs 26a and 26b protrude in the vertical direction (top-bottom direction).

In a fourth example shown in FIGS. 10A and 10B, as shown in FIG. 10A, a die matching surface between the cavity die 40 and the slide core die 42 is substantially in parallel to the door width direction W at both edges of the defroster/face door 26 in the door width direction W. A die matching surface between the core die 41 and the slide core die 42 is perpendicular to the door width direction W at a position apart from the both edges of the defroster/face door 26 in the door width direction W by a predetermined distance.

Thus, as shown in FIG. 10B, the burr 26a occurring in a die matching portion between the cavity die 40 and the slide core die 42 protrudes substantially in parallel to the door width direction W at both edges of the defroster/face door 26 in the door width direction W. The burr 26b occurring in a die matching portion between the core die 41 and the slide core die 42 protrudes in the direction perpendicular to the door width direction W (vertically shown in FIG. 10B) at a position apart from the both edges of the defroster/face door 26 in the door width direction W by a predetermined distance.

Next, the outline of an electric controller of this embodiment will be described below. Various types of actuators, including respective servo motors for the air mix door 20, the defroster/face door 26 and the foot door 28 as described above, and electric motor 23 and the like for the first and second blowers 21 and 22 are connected to the output side of an air conditioning controller not shown. The operations of these actuators are controlled based on a control signal output from the air conditioning controller.

The air conditioning controller is constructed of a known microcomputer including a CPU, a ROM, and a RAM, and a peripheral circuit thereof. The air conditioning controller stores therein an air conditioning device control program in the ROM, and performs various types of computation and processing based on the air conditioning device control program, thereby controlling the operation of an air conditioning control device connected to the output side.

An operation panel is connected to the input side of the air conditioning controller. The operation panel is provided with a group of sensors for detecting vehicle environmental states, such as an outside air temperature Tam, an inside air temperature Tr, an amount of solar radiation Ts entering the vehicle compartment, and the like. The operation panel is also provided with an operation switch for outputting an operation command signal to the air conditioner for a vehicle, and a temperature setting switch or the like for setting a target temperature Tset of the vehicle compartment.

Next, the operation of this embodiment with the above-mentioned arrangement will be described below. In an operating state of the vehicle, when the operation switch is turned on, the air conditioning controller executes the program for control of the air conditioner, which is stored in the ROM. In execution of the program, detection signals detected by the above-mentioned sensor group and an operation signal of the operation panel are read in. A target air outlet temperature TAO of air to be blown out into the vehicle compartment is calculated based on these signals.

Then, the air conditioning controller determines the number of revolutions of the first and second blowers 21 and 22 (amount of air blown), opened and closed states of the defroster/face door and the foot door (air outlet mode), and a target opening degree or the like of the air mix door 20 based on the target air outlet temperature TAO. The controller outputs control signals to various actuators so as to obtain the control state determined.

A control routine is repeated again which involves reading an operation signal and a detection signal, calculating a TAO, determining a new control state, and outputting a control signal.

Now, the control of the opening and closing states of the defroster/face door 26 and the foot door 28 (air outlet modes) will be described below. The air outlet mode is determined based on the target air outlet temperature TAO with reference to a control map pre-stored in the air conditioning controller. In this embodiment, as the target air outlet temperature TAO increases from a low temperature range to a high temperature range, the air outlet mode is switched from a face mode to a bi-level mode and then to a foot mode in that order.

Now, the opening and closing states of the defroster/face door 26 and the foot door 28 in the respective air outlet modes will be described below.

The face mode is a mode in which the conditioned air is blown out from the face air outlet toward the face area of the passenger in the vehicle compartment. Thus, in the face mode, the defroster/face door 26 is operated to move to a position where the face opening 25 is completely opened. The foot door 28 is operated to rotate and move to a position where the foot opening 27 is completely opened.

The foot mode is a mode in which the conditioned air is blown out from the foot air outlet toward the foot area of the passenger. Thus, in the foot mode, the defroster/face door 26 is operated to move to a position where the face opening 25 is completely closed, and the foot door 28 is operated to rotate and move to a position where the foot opening 27 is completely opened.

The bi-level mode is a mode in which a part of conditioned air is blown out from the face air outlet toward the face area of the passenger and at the same time the other part of conditioned air is blown out from the foot air outlet toward the foot area of the passenger. Thus, in the bi-level mode, the defroster/face door 26 is operated to move to a position where the face opening 25 is opened, and the foot door 28 is operated to rotate and move to a position where the foot opening 27 is opened.

A defroster mode can be performed as one of the air outlet modes. The defroster mode can be performed by a passenger's manual operation, and the conditioned air is blown out from the defroster air outlet toward a vehicle windshield. Thus, in the defroster mode, the defroster/face door 26 is operated to move to a position where the defroster opening 24 is completely opened.

In this embodiment, the recessed space 32a is provided in the driven side gear 32. This can prevent the deformation of a connection portion between the door body 30 and the driven side gear 32 due to a contraction force in the molding, and also the occurrence of the “sink” in the driven side gear 32 when the door body 30 and the driven side gear 32 are integrally molded using resin for the same reason as that in the above-mentioned examination example.

Specifically, the recessed space 32a is provided in the driven side gear 32 to make the driven side gear 32 thin, so that the thicknesses of the door body 30 and the driven side gear 32 are made uniform.

Thus, the door body 30 and the driven side gear 32 can have the uniform cooling rate when the body 30 and the gear 32 are integrally molded using resin, thereby preventing the deformation of the connection portion between the door body 30 and the driven side gear 32 due to the constriction force.

The provision of the recessed space 32a makes the driven side gear 32 thin, thereby enabling prevention of occurrence of the “sink”.

Since the recessed space 32a is laid to extend in the door width direction in this embodiment, the recessed space 32a can be prevented from being opened to the plate surface 30a of the door body 30 on the downstream air side. Thus, the plate surface 30a on the downstream air side tightly abuts against the seal surface 24a on the case side as indicated by a part enclosed by the broken line shown in FIG. 5, so as to improve the sealing performance.

For illustrative convenience, as shown in FIG. 5, the plate surface 30a on the downstream air side is spaced apart from the case-side seal surface 24a, but actually abuts against the case-side seal surface 24a.

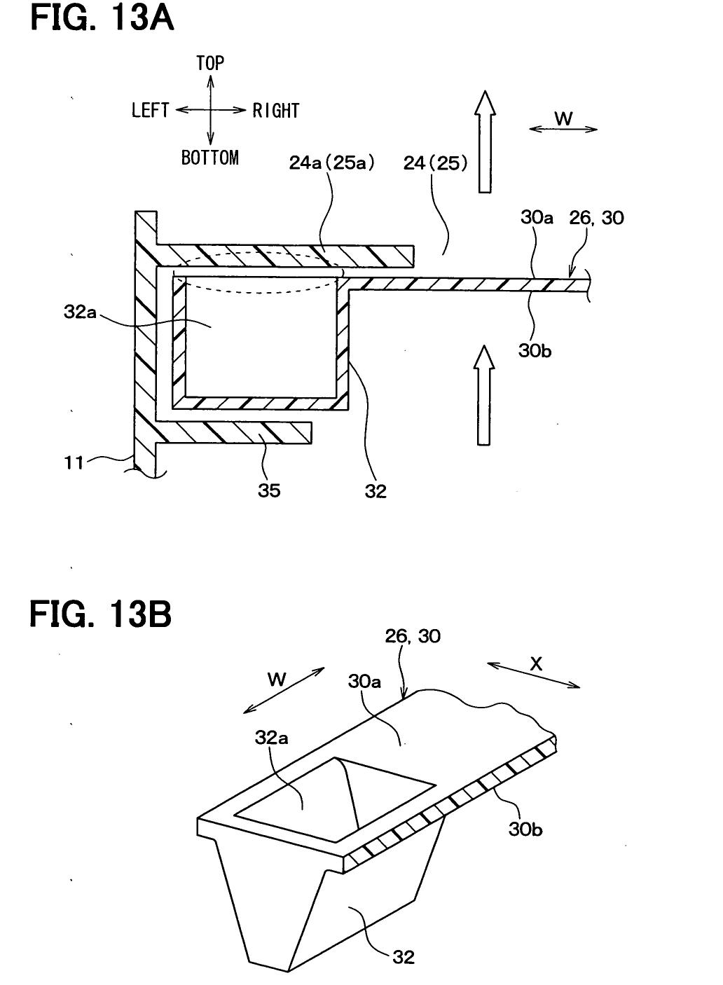

That is, in the first embodiment unlike the examination example shown in FIG. 13A, in order to ensure the sealing performance, it is not necessary to cause the seal surface 24a on the case side to largely protrude toward the center side of the door body 30 in the door width direction W. As a result, the area of the defroster opening 24 or the face opening 25 can be prevented from being decreased, unlike the examination example shown in FIGS. 13A and 13B.

As mentioned above, the first embodiment can achieve an integral molding of the door body 30 and the driven side gear 32 using resin, and also can prevent a decrease in the area of the defroster opening 24. Also, in the face opening 25, the decrease in opening area can be prevented, similarly to the defroster opening 24.

In the first example shown in FIGS. 7A and 7B, the burrs 26a and 26b occurring in integral molding of the door body 30 and the driven side gear 32 protrude toward the case-side seal surface 24a and the guide wall surface 35. In this case, the burr 26a slides on the case-side seal surface 24a and the burr 26b slides on the guide wall surface 35, so that these burrs 26a and 26b may cause abnormal noise or failure in operation.

In this regard, in the second to fourth examples shown in FIGS. 8A to 10B, the burr 26a is formed at a portion of the door body 30 other than a portion thereof contacting the case-side seal surface 24a, and the burr 26b is formed at a portion of the driven side gear 32 other than a portion thereof contacting the guide wall surface 35. Accordingly, it can prevent the burrs 26a and 26b from sliding on the case-side seal surface 24a and the guide wall surface 35, thereby preventing the burrs 26a and 26b from causing the abnormal noise and the failure in operation.

### Second Embodiment

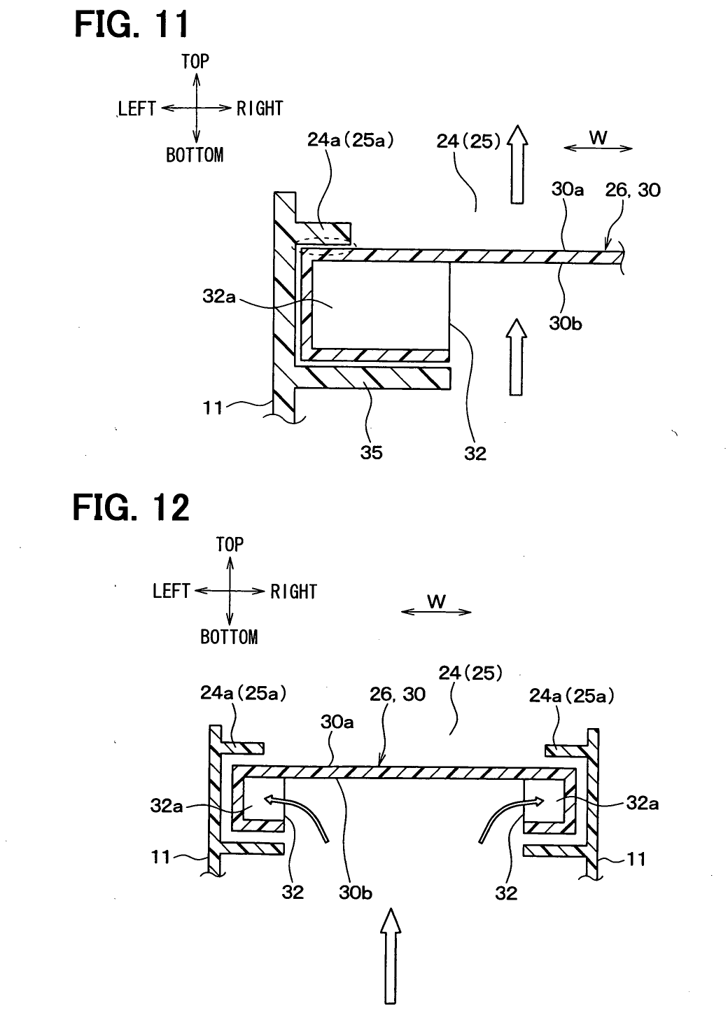

In the above-described first embodiment, the recessed space 32a is laid-drawn in the door width direction W from the outside of the driven side gear 32. That is, in the above-described first embodiment, the recessed space 32a is open from the outside of the driven side gear 32 and extends toward the center side in the door width direction W. However, in a second embodiment, as shown in FIG. 11, the recessed space 32a is laid-drawn in the door width direction W from the inside of the driven side gear 32. That is, in the second embodiment, the recessed space 32a is open from the inside of the driven side gear 32 and extends toward the outside end in the door width direction W.

Thus, the second embodiment can obtain the same operation and effect as those in the first embodiment.

Furthermore, in this embodiment, the air blown toward the defroster opening 24 flows into the recessed space 32a as indicated by the arrows shown in FIG. 12, causing the plate surface 30a on the downstream air side to be pushed toward the seal surface 24a on the case side. This can improve the sealing performance.

Alternatively, the recessed space 32a may extend in the door width direction W to open at two sides in the door width direction W.

### Other Embodiments

Although the present invention has been fully described in connection with the preferred embodiments thereof with reference to the accompanying drawings, it is to be noted that various changes and modifications will become apparent to those skilled in the art.

For example, although in each of the above-mentioned embodiments, an air passage opening and closing device of the invention is typically used for the air-outlet mode switching door of the air conditioner for a vehicle, the invention is not limited thereto. The air passage opening and closing device of the invention can be used for an air mix door or an inside/outside air switching door in an air conditioner for a vehicle, for example. Furthermore, the air passage opening and closing device of the present invention may be used as any air passage switching device for opening and closing an opening portion of an air passage.

Although in each of the above-mentioned embodiments, the guide wall surface 35 is formed on the side wall of the case 11, it is not always necessary to form the guide wall surface 35.

The invention can be widely applied to various types of air passage opening and closing devices, including an air passage opening and closing device in an air conditioner set in a house, a building, or the like.

According to the above-described first and second embodiments of the present invention and the modifications thereof, an air passage opening and closing device includes a case (11) configured to define an opening portion (24, 25) of an air passage, a sliding door (26) slidably disposed in the case (11) to open and close the opening portion (24, 25), and a gear mechanism (31) configured to drive the sliding door (26) and to move the sliding door (26) in a door movement direction (X). The sliding door (26) includes a resinous door body (30) having a plate-like shape, and the door body (30) has first and second plate surfaces (30a, 30b) opposite to each other. The case (11) has a case-side seal surface (24a, 25a) at two edges of the opening portion in a width direction (W) of the door body (30), and the case-side seal surface (24a, 25a) is adapted to abut against the first plate surface (30a) of the door body (30). The gear mechanism (31) includes a driven side gear (32) that is integrally molded with the door body (30) using resin, and a driving side gear (33) that is located to be engaged with the driven side gear (32). Furthermore, the driven side gear (32) protrudes from the second plate surface (30b) of the door body (30) and extends in a direction parallel with the door movement direction (X), at two edge portions of the

What is claimed is:

1. An air passage opening and closing device comprising:
a case configured to define an opening portion of an air passage;
a sliding door slidably disposed in the case to open and close the opening portion, the sliding door including a resinous door body having a plate-like shape; and
a gear mechanism configured to drive the sliding door and to move the sliding door in a door movement direction,
wherein the door body has first and second plate surfaces opposite to each other,
wherein the case has a case-side seal surface at two edges of the opening portion in a width direction of the door body, the case-side seal surface being adapted to abut against the first plate surface of the door body,
wherein the gear mechanism includes a driven side gear that is integrally molded with the door body using resin, and a driving side gear that is located to be engaged with the driven side gear,
wherein the driven side gear protrudes from the second plate surface of the door body and extends in a direction parallel with the door movement direction, at two edge portions of the second plate surface of the door body in the width direction, and
wherein the driven side gear has a hollow space opened toward a direction parallel to the width direction.

2. The air passage opening and closing device according to claim 1, wherein the hollow space is opened from an inner side of the door body toward an outside of the door body in the width direction.

3. The air passage opening and closing device according to claim 1, wherein the hollow space is opened from an outside of the door body toward an inner side of the door body in the width direction.

4. The air passage opening and closing device according to claim 2, wherein the door body and the driven side gear are integrally molded to have a burr that is positioned at a portion of the door body, other than a contact portion of the door body that contacts the case-side seal surface.

5. The air passage opening and closing device according to claim 2, wherein the case is configured to have a guide wall surface on which the driven side gear slides, the guide wall surface being opposite to the case-side seal surface, and
wherein the door body and the driven side gear are integrally molded to have a burr that is positioned at a portion of the door body other than a contact portion of the door body that contacts the case-side seal surface, and at a portion of the driven side gear other than a contact portion of the driven side gear that contacts the guide wall surface.

6. The air passage opening and closing device according to claim 1, wherein the door body and the driven side gear have approximately a uniform thickness.

7. The air passage opening and closing device according to claim 1, wherein the driven side gear has a plurality of protrusion portions each of which is connected with the second plate surface of the door body to define the hollow space,
wherein the protrusion portions are continuously arranged on the second plate surface of the door body in the door movement direction, and
wherein the protrusion portion is open only toward the width direction at least at one end side.

8. The air passage opening and closing device according to claim 1, wherein the first plate surface of the door body is positioned on a downstream air side in a flow direction of air flowing in the air passage, and the second plate surface of the door body is positioned on an upstream air side in the flow direction.

9. A method for manufacturing the air passage opening and closing device according to claim 4, the method comprising
integrally molding the door body and the driven side gear by a forming die,
wherein the forming die includes a cavity die and a core die that are divided into a side of the first plate surface and a side of the second plate surface, and a slide core die for forming the hollow space, and
wherein a die matching position between the slide core and one of the cavity die and the core die on the side of the first plate surface is set in a portion of the door body, other than a contact portion of the door body contacting the case-side seal surface.

10. A method for manufacturing the air passage opening and closing device according to claim 5, the method comprising
integrally molding the door body and the driven side gear by a forming die,
wherein the forming die includes a cavity die and a core die that are divided into a side of the first plate surface and a side of the second plate surface, and a slide core die for forming the hollow space,
wherein a die matching position between the slide core and one of the cavity die and the core die on the side of the first plate surface is set in a portion of the door body, other than a contact portion of the door body contacting the case-side seal surface, and
wherein a die matching position between the slide core and the other one of the cavity die and the core die on the side of the second plate surface is set in a portion of the driven side gear, other than a contact portion of the driven side gear contacting the guide wall surface.
